(19) United States
(12) Patent Application Publication
(10) Pub. No.: US 2026/0197412 A1
(43) Pub. Date: Jul. 9, 2026

(54) INFORMATION PROCESSING APPARATUS, CONTROL METHOD THEREFOR, AND STORAGE MEDIUM FOR FACILITATING GENERATION OF IMAGE DATA FROM HANDWRITTEN MANUSCRIPT

(71) Applicant: CANON KABUSHIKI KAISHA, Tokyo (JP)

(72) Inventor: JUN TANAKA, Ibaraki (JP)

(21) Appl. No.: 19/417,925

(22) Filed: Dec. 12, 2025

(30) Foreign Application Priority Data
Jan. 7, 2025 (JP) 2025-002282

(51) Int. Cl. H04N 1/00; G06V 10/26; G06V 10/56; G06V 30/148; G06V 30/18; G06V 30/22; G06V 30/244; G06V 30/413

(52) U.S. Cl. CPC H04N 1/00816; G06V 10/56; G06V 30/18105; G06V 30/22; G06V 30/245; G06V 30/413; H04N 2201/0094

(57) ABSTRACT

An information processing apparatus is configured to acquire image data obtained by reading a manuscript and detect a character region including one or more characters from the image data. The information processing apparatus is further configured to determine whether the detected character region satisfies a predetermined condition. When the character region satisfies the condition, the information processing apparatus performs processing on the image data to replace the character region with an image of an object indicated by the characters included in the character region.

### BACKGROUND

### Field of the Technology

The present disclosure relates to an information processing apparatus, a control method for the information processing apparatus, and a storage medium.

### Description of the Related Art

It is common to print simple content on paper and display it to provide guidance or draw attention. While handwritten notes are often used in settings such as workplaces or homes to communicate with relatively familiar people, neatly prepared postings are required for addressing customers or passersby. However, creating image data on a personal computer (PC) or smartphone and printing it just to display such simple content can be cumbersome. In view of this, a technology has been proposed in which characters contained in a manuscript are recognized and replaced with images of characters in a predetermined font (see Japanese Patent Application Laid-Open No. 2000-222158).

However, in the conventional technology described above, it is not possible to insert an image of an object such as an illustration or a figure, and the user is required to manually create non-text portions by handwriting. Alternatively, the user is required to operate a PC or smartphone to trim or resize the object image to be inserted to fit the desired region, which is time-consuming and cumbersome.

### SUMMARY

Embodiments described herein are directed to technology capable of generating image data including an image of an object such as an illustration or a figure from a handwritten manuscript and arranging it in a region that satisfies a predetermined condition.

In one embodiment, an information processing apparatus includes one or more processors and at least one memory. The memory is coupled to the one or more processors and stores instructions that, when executed by the one or more processors, cause the one or more processors to perform operations. The operations include acquiring image data obtained by reading a manuscript and detecting a character region including one or more characters from the image data. The operations further include determining whether the detected character region satisfies a predetermined condition and performing, when the character region satisfies the condition, processing on the image data to replace the character region with an image of an object indicated by the one or more characters included in the character region.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram schematically illustrating the configuration of an information processing system including a server as an information processing apparatus according to an embodiment.

FIG. 2 is a block diagram schematically illustrating the software configuration of an MFP illustrated in FIG. 1.

FIG. 3 is a block diagram schematically illustrating the software configuration of the server illustrated in FIG. 1.

FIG. 4 is a flowchart illustrating the operation of the MFP in an image conversion process performed by the information processing system illustrated in FIG. 1.

FIGS. 5A and 5B are diagrams each illustrating an example of a screen displayed on the operation unit illustrated in FIG. 1.

FIGS. 6A and 6B are diagrams each illustrating an example of a manuscript and image data used in an embodiment.

FIGS. 7A to 7C are diagrams each illustrating an example of a screen displayed on a display of a mobile terminal illustrated in FIG. 1.

FIG. 8 is a flowchart illustrating the operation of the server in the image conversion process performed by the information processing system illustrated in FIG. 1.

FIGS. 9A and 9B are diagrams each illustrating an example of an image used for training an image generation AI provided in the server illustrated in FIG. 1.

FIG. 10 is a flowchart illustrating a procedure of an image conversion process performed by the MFP illustrated in FIG. 1.

FIG. 11 is a flowchart illustrating a procedure of a conversion process performed in step S1005 of FIG. 10.

### DESCRIPTION OF THE EMBODIMENTS

An information processing apparatus according to an example embodiment will be described below with reference to the accompanying drawings.

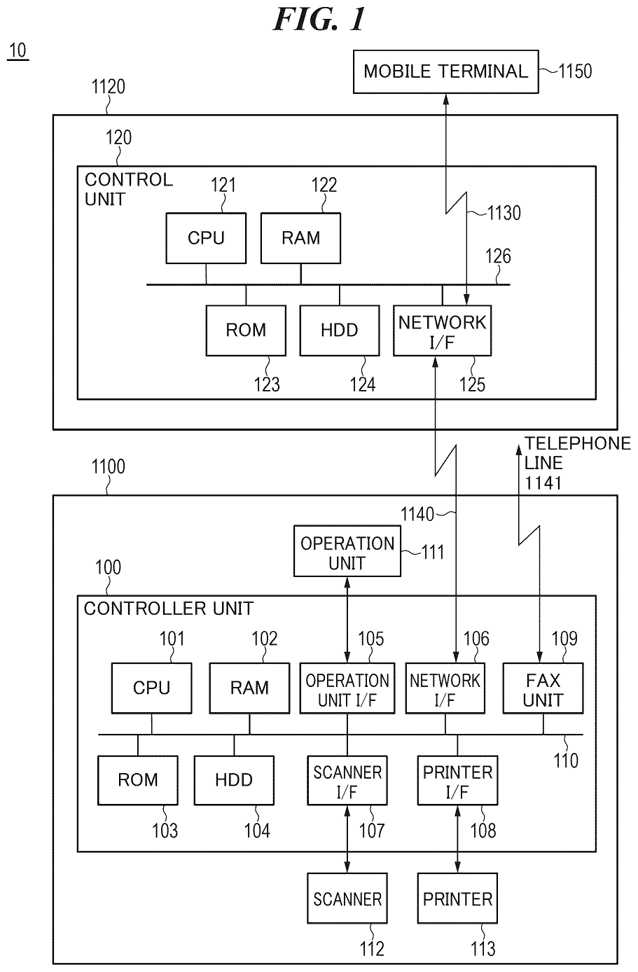

FIG. 1 is a block diagram schematically illustrating the configuration of an information processing system 10 including a server as an information processing apparatus according to an embodiment. In this embodiment, a multifunction peripheral (MFP) having copy and print functions is described as an example of an image forming apparatus that performs reading and printing of a document or manuscript.

As illustrated in FIG. 1, the information processing system 10 includes an MFP 1100, a server 1120 serving as an information processing apparatus, and a mobile terminal 1150. The information processing system 10 performs an image conversion process using an image generation AI. In the image conversion process, image data obtained by reading a manuscript that contains handwritten characters or symbols is converted into image data that includes an image of the object indicated by the handwritten characters or images of characters obtained by converting the handwritten characters into a predetermined font such as MS Mincho or MS Gothic. In the information processing system 10, the MFP 1100 is connected to the server 1120 via a network such as a LAN 1140, and the mobile terminal 1150 is connected to the server 1120 via a network such as a LAN 1130 different from the LAN 1140. In this embodiment, as one example, a configuration is described in which the mobile terminal 1150 and the MFP 1100 are connected to different networks. However, the embodiment is not limited to this configuration, and the mobile terminal 1150 and the MFP 1100 may be connected to the same network.

The MFP 1100 includes a controller unit 100. The controller unit 100 is connected to a scanner 112, a printer 113, an operation unit 111, and the LAN 1140. The controller unit 100 includes a CPU 101, a RAM 102, a ROM 103, an HDD 104, an operation unit I/F 105, a network I/F 106, a scanner I/F 107, a printer I/F 108, and a FAX unit 109. These components are interconnected via a system bus 110.

The CPU 101 executes a boot program stored in the ROM 103 to start the MFP 1100. Additionally, the CPU 101 reads a control program stored in the HDD 104 and performs predetermined processing using the RAM 102 as a work area.

The RAM 102 is used as a work area for the CPU 101 and also as a temporary storage area for various data. The ROM 103 stores the boot program and the like. The HDD 104 stores a plurality of control programs for implementing functions such as a copy function and a print function. The HDD 104 also stores image data generated by the scanner 112 reading a manuscript.

The operation unit I/F 105 controls data input/output communication with the operation unit 111. The network I/F 106 is connected to the LAN 1140 and controls data communication via the LAN 1140.

The scanner I/F 107 outputs scanner control data acquired from the CPU 101 to the scanner 112. The scanner I/F 107 also acquires image data obtained by reading a manuscript through a scanning process based on the scanner control data from the scanner 112. The printer I/F 108 outputs printer control data acquired from the CPU 101 and image data to be printed to the printer 113. The FAX unit 109 transmits and receives facsimile data via a telephone line 1141.

The operation unit 111 includes an input device such as a touch panel or hardware keys, as well as a display device such as an LCD or LED, and serves as an interface that receives various instructions from a user and displays various information. The hardware keys include, for example, a start button for instructing the start of scanning a paper document.

The scanner 112 includes an optical reading device such as a charge-coupled device (CCD) and has a function of optically scanning a paper medium to read it as electronic image data. In addition, the scanner 112 is provided with an automatic document feeder (ADF), which automatically feeds sheets one by one from a stack of documents placed on the document tray to the optical reading section and discharges the sheets after reading. Whether a document is placed on the document tray of the ADF can be determined using a sensor (not illustrated) or the like. The printer 113 has a function of forming electronic image data as an image on a recording medium such as paper.

The server 1120 is connected to the MFP 1100 via a network such as the LAN 1140 and receives information such as logs and notifications transmitted from the MFP 1100.

The server 1120 includes a control unit 120 that can be connected to the LAN 1140. The control unit 120 includes a CPU 121, a RAM 122, a ROM 123, an HDD 124, and a network I/F 125. These components are interconnected via a system bus 126.

The CPU 121 controls the overall operation of the server 1120. The CPU 121 reads a control program stored in the ROM 123 or the HDD 124 and performs predetermined processing using the RAM 122 as a work area. The RAM 122 is used as a work area for the CPU 121 and also as a temporary storage area for various data. The ROM 123 stores a boot program.

The HDD 124 stores a control program for transmitting and receiving image data, a control program related to an image conversion process, and the like. The network I/F 125 controls the input and output of information via the LAN 1130 and the LAN 1140. For example, the network I/F 125 receives image data from the MFP 1100 via the LAN 1140. In addition, the network I/F 125 receives instructions to change various settings from the mobile terminal 1150 via the LAN 1130.

The mobile terminal 1150 is connected to the server 1120 via a network such as the LAN 1130. The mobile terminal 1150 accesses the server 1120 and displays a settings screen provided by the server 1120 on a web browser of the mobile terminal 1150. A user can configure settings related to an image conversion process through the settings screen.

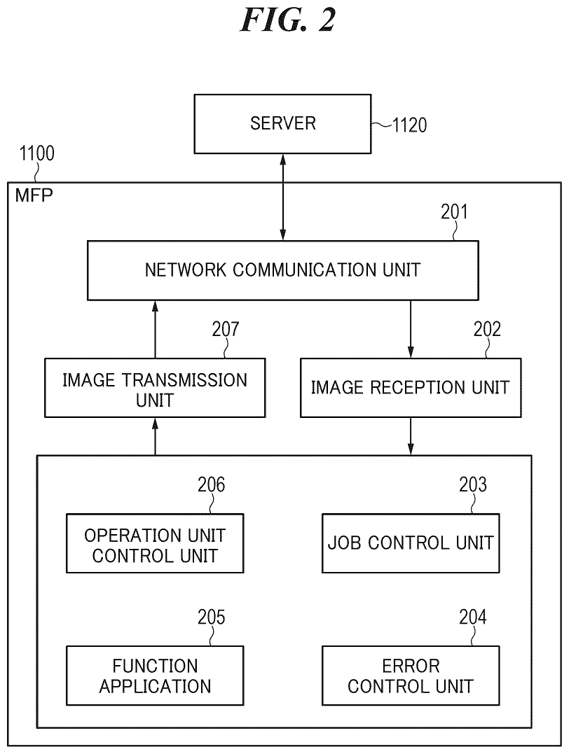

FIG. 2 is a block diagram schematically illustrating the software configuration of the MFP 1100 illustrated in FIG. 1. As illustrated in FIG. 2, the MFP 1100 includes a network communication unit 201, an image reception unit 202, a job control unit 203, an error control unit 204, a function application 205, an operation unit control unit 206, and an image transmission unit 207. Control programs are stored in any of the RAM 102, the ROM 103, or the HDD 104, and the functions of these software modules are implemented when the CPU 101 executes the control programs.

The network communication unit 201 controls the network I/F 106 to perform data communication via a network such as the LAN 1140. The image reception unit 202 stores, in the HDD 124, image data received from the server 1120 or the like via the network I/F 106.

The job control unit 203 controls the scanner 112 via the scanner I/F 107 to perform a scanning process in accordance with a scan execution instruction received from the function application 205. The job control unit 203 also controls the printer 113 via the printer I/F 108 to perform a printing process in accordance with a print execution instruction received from the function application 205. The error control unit 204 performs control to stop the entire system or issues an instruction for a degraded operation upon receiving a notification of an abnormal condition occurring in the job control unit 203, the printer 113, the scanner 112, or the like.

The function application 205 is software that implements various functions, such as a copy function, a print function, and an email transmission function, and includes a plurality of applications for respective functions. These applications operate in response to triggers such as an instruction from a user through the operation unit 111 or reception of data via a network such as the LAN 1140. The operation unit control unit 206 has a function of controlling the operation unit I/F 105 to display a screen for user operation on the operation unit 111 and a function of conveying the contents of operations performed by the user on the operation unit 111 to other software. The operation unit control unit 206 primarily controls the operations and displays with respect to the hardware of the operation unit 111. The image transmission unit 207 transmits, for example, image data generated by the scanner 112 to the server 1120 or the like via the network I/F 106.

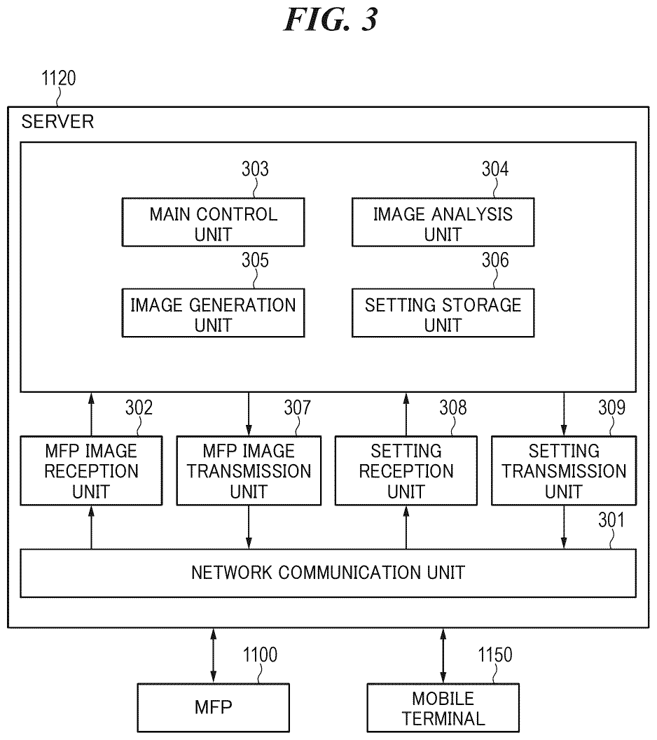

FIG. 3 is a block diagram schematically illustrating the software configuration of the server 1120 illustrated in FIG. 1. As illustrated in FIG. 3, the server 1120 includes a network communication unit 301, an MFP image reception unit 302, a main control unit 303, an image analysis unit 304, an image generation unit 305, a setting storage unit 306, an MFP image transmission unit 307, a setting reception unit 308, and a setting transmission unit 309. Control programs are stored in any of the RAM 122, the ROM 123, or the HDD 124, and the functions of these software modules are implemented when the CPU 121 executes the control programs.

The network communication unit 301 controls the network I/F 125 to perform data communication via a network such as the LAN 1130 or the LAN 1140.

The MFP image reception unit 302 receives image data from the MFP 1100 or the like via the network I/F 125. The received image data is stored in the HDD 124, and the main control unit 303 is notified that the image data has been received.

The main control unit 303 performs processing on the received image data in accordance with settings retrieved from the setting storage unit 306. For example, the main control unit 303 instructs the image analysis unit 304 to analyze information contained in image data obtained by reading a handwritten manuscript. The main control unit 303 also instructs the image generation unit 305 to generate new image data in which a character region including handwritten characters is replaced with an image of the object indicated by the characters based on the analysis result from the image analysis unit 304. Additionally, the main control unit 303 instructs the MFP image transmission unit 307 to transmit the generated image data to the MFP 1100.

The image analysis unit 304 analyzes information contained in the image data in accordance with an instruction from the main control unit 303. In this embodiment, the image analysis unit 304 performs figure detection and character recognition.

The image generation unit 305 generates or converts image data in accordance with an instruction from the main control unit 303. For example, the image generation unit 305 can generate new image data by arranging image data and font data stored in the HDD 124. In addition, the image generation unit 305 has the functionality of an image generation AI and can also output new image data using a trained model that has learned from a large number of images.

The setting storage unit 306 analyzes a setting change instruction received from the mobile terminal 1150 or the like via the network I/F 125 and stores the analyzed content as settings in the HDD 124. The setting storage unit 306 also responds with the content of settings in response to a request from the setting transmission unit 309 or the main control unit 303.

The MFP image transmission unit 307 controls the network I/F 125 to transmit image data to the MFP 1100 in accordance with an instruction from the main control unit 303. At this time, not only the image data but also processing results, print settings, and the like are transmitted to the MFP 1100 simultaneously.

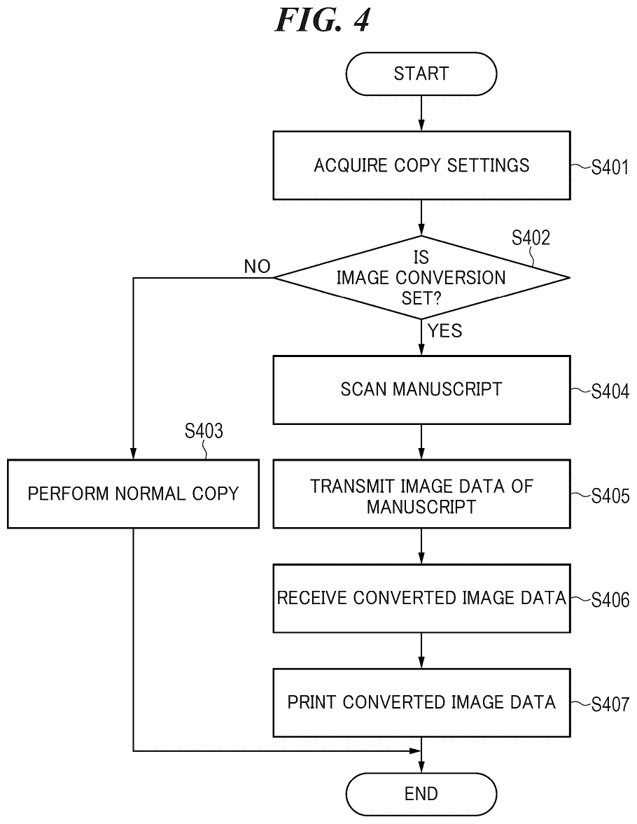

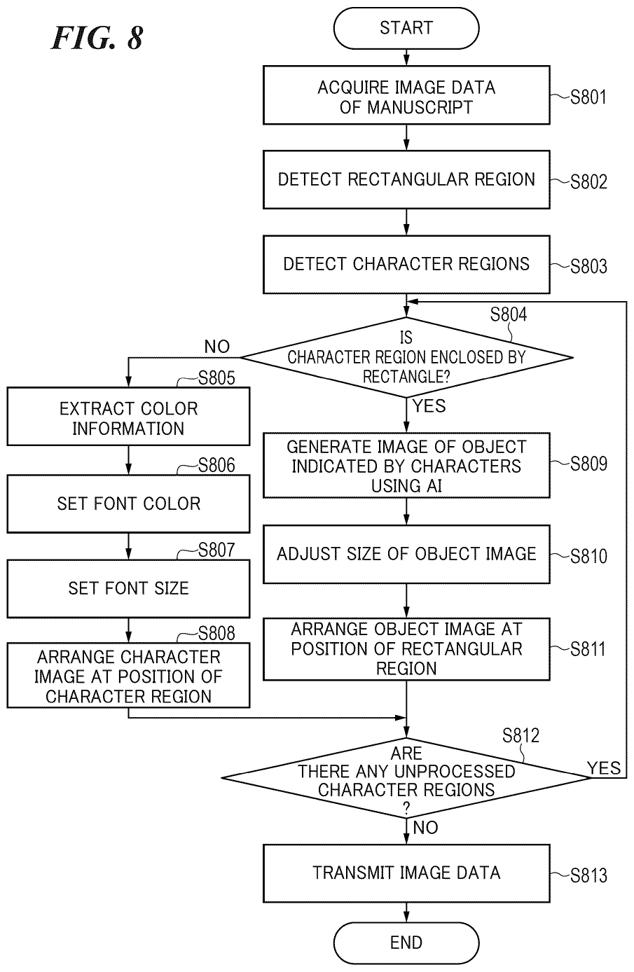

Next, an image conversion process using an image generation AI, performed by the information processing system 10, will be described. In the image conversion process, as described above, image data obtained by reading a manuscript that contains handwritten characters or symbols is converted into image data that includes an image of the object indicated by the handwritten characters or an image of a character string obtained by converting the handwritten characters into a font. The operation of the MFP 1100 in the image conversion process is illustrated in FIG. 4, and the operation of the server 1120 in the image conversion process is illustrated in FIG. 8.

First, the operation of the MFP 1100 in the image conversion process will be described.

FIG. 4 is a flowchart illustrating the operation of the MFP 1100 in the image conversion process performed by the information processing system 10 illustrated in FIG. 1. The flowchart of FIG. 4 is implemented when the CPU 101 loads the control program of the function application 205 stored in the ROM 103 or the HDD 104 into the RAM 102 and executes it. The flowchart of FIG. 4 is initiated, for example, when the MFP 1100 receives an instruction from a user to perform copying.

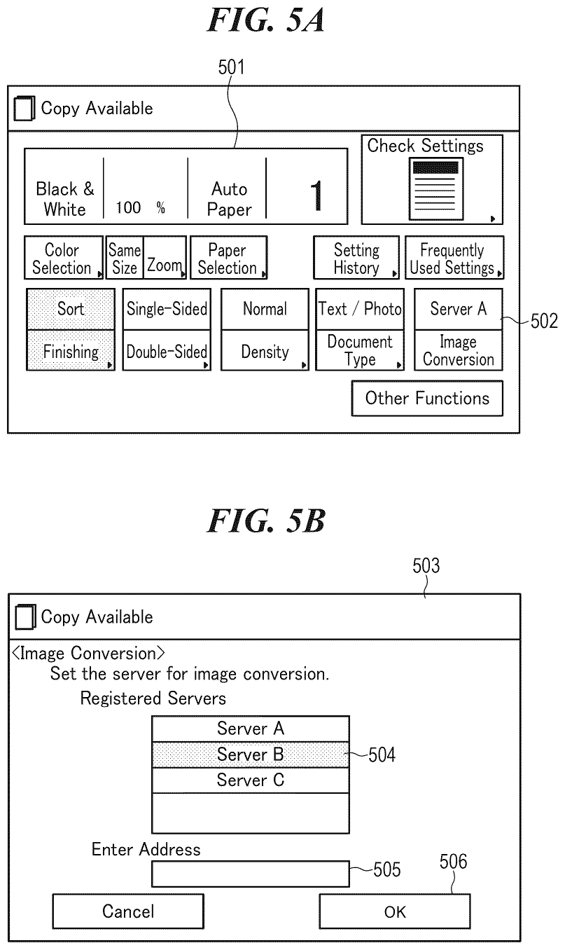

In FIG. 4, first, the function application 205 acquires copy settings configured by the user (S401). In this embodiment, the user can configure copy settings on a copy settings screen 501, illustrated in FIG. 5A, which is displayed on the operation unit 111.

The copy settings screen 501 includes a plurality of buttons arranged for configuring various settings related to the copy function. Among these buttons is an image conversion settings button 502. When the user presses the image conversion settings button 502, the screen on the operation unit 111 switches to an image conversion settings screen 503 illustrated in FIG. 5B.

The image conversion settings screen 503 is a screen for configuring settings related to the image conversion process. In this embodiment, it is assumed that the image conversion settings screen 503 is used only to select the server to perform the image conversion process, and detailed settings related to the image conversion process are made on the mobile terminal 1150 side. However, the embodiment is not limited to such a configuration. The detailed settings related to the image conversion process may also be made on the image conversion settings screen 503 and transmitted to the server selected on the image conversion settings screen 503.

The image conversion settings screen 503 includes a server selection section 504, an address input section 505, and an OK button 506. The server selection section 504 displays a list of servers previously registered as capable of performing the image conversion process. The user can select a server from this list. In addition, the user can specify a desired server by entering information that identifies the server in the address input section 505. When pressing the OK button 506 after selecting a server in the server selection section 504 or entering information in the address input section 505, the user can set image conversion for performing the image conversion process. The server specified by the user in the server selection section 504 or the address input section 505 is set as the server to perform the image conversion process. In step S401, the setting values configured on the copy settings screen 501 and the image conversion settings screen 503 are acquired as copy settings.

Referring back to FIG. 4, the function application 205 determines whether image conversion has been set based on the acquired copy settings (S402). If it is determined that image conversion has not been set, the function application 205 instructs the job control unit 203 to perform a normal copy operation in which image data obtained by reading a manuscript is copied as is (S403). Thereafter, the process ends.

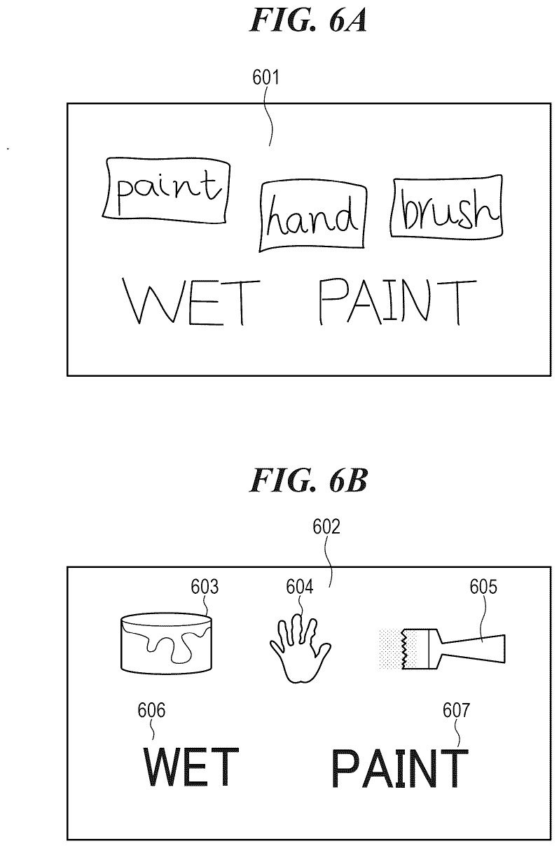

If it is determined in step S402 that image conversion has been set, the function application 205 instructs the job control unit 203 to scan the set manuscript (S404). In this embodiment, it is assumed that a manuscript 601 illustrated in FIG. 6A is scanned. The manuscript 601 includes the handwritten words “paint,” “hand,” and “brush”, each enclosed in a handwritten rectangle. The manuscript 601 further includes the handwritten words “WET” and “PAINT,” which are not enclosed in a handwritten rectangle. The image data obtained by scanning the manuscript 601 (hereinafter referred to as “image data of the manuscript 601”) is stored in the HDD 124.

Next, the function application 205 instructs the image transmission unit 207 to transmit the image data of the manuscript 601 to the server specified on the image conversion settings screen 503 (S405). In this embodiment, as an example, it is assumed that the server 1120 has been specified on the image conversion settings screen 503. The server 1120 operates according to the flowchart illustrated in FIG. 8 (described later) and converts the received image data of the manuscript 601 into image data 602 illustrated in FIG. 6B (hereinafter referred to as “converted image data”). How the image data of the manuscript 601 is converted to obtain the converted image data 602 will be described later.

Next, the function application 205 instructs the image reception unit 202 to wait for the converted image data. Upon receiving the instruction, the image reception unit 202 waits until it receives the converted image data from the server 1120. When the image reception unit 202 receives the converted image data 602 (S406), the converted image data 602 is stored in the HDD 124.

Next, the function application 205 instructs the job control unit 203 to print the received converted image data 602 (S407). The job control unit 203 prints the received converted image data 602 in accordance with the print-related settings among the copy settings. Thereafter, the process ends.

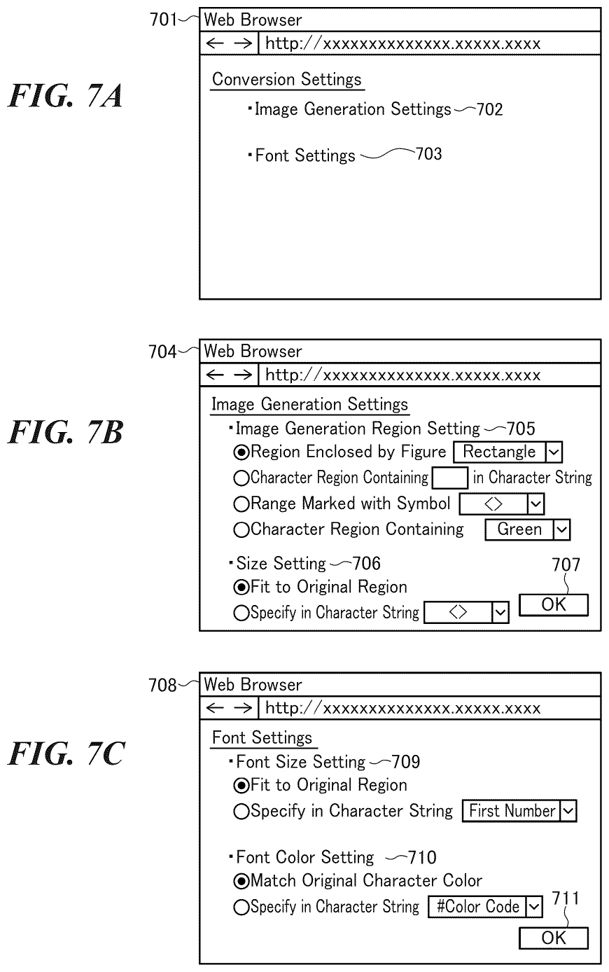

Next, the operation of the server 1120 in the image conversion process will be described. In this embodiment, before the image conversion process is performed, the user configures detailed settings related to the image conversion process in advance from the mobile terminal 1150. For example, when the user accesses the server 1120 from the mobile terminal 1150, the setting transmission unit 309 of the server 1120 transmits response data to the mobile terminal 1150 in accordance with an HTTP request received from the mobile terminal 1150. The response data includes information for composing a screen for configuring the detailed settings mentioned above. In addition, the setting reception unit 308 acquires information entered on the screen displayed on the display of the mobile terminal 1150 and changes the detailed settings related to the image conversion process based on this information. In this manner, in the present embodiment, the user can configure detailed settings related to the image conversion process using a web browser on the mobile terminal 1150 or the like. In the following, as an example, it is assumed that the screens illustrated in FIGS. 7A to 7C are displayed on the display of the mobile terminal 1150 operated by the user via a web browser.

FIG. 7A illustrates an item selection screen 701. The item selection screen 701 includes, as items for detailed settings related to the image conversion process, image generation settings 702 and font settings 703. When the user selects the image generation settings 702, the screen on the display of the mobile terminal 1150 transitions to an image generation settings screen 704 illustrated in FIG. 7B. Similarly, when the user selects the font settings 703, the screen on the display of the mobile terminal 1150 transitions to a font settings screen 708 illustrated in FIG. 7C.

FIG. 7B illustrates the image generation settings screen 704. The image generation settings screen 704 includes, as setting items, an image generation region setting 705 and a size setting 706.

The image generation region setting 705 allows the user to set a condition for detecting a character region in which an object image is to be arranged in the image conversion process. In this embodiment, the user can select one of the following conditions: “Region Enclosed by Figure,” “Character Region Containing [a specified character] in Character String,” “Range Marked with Symbol,” or “Character Region Containing [a specified color].”

When “Region Enclosed by Figure” is selected, a character region enclosed by a figure of a shape (e.g., a rectangle or a circle) specified by the user is detected, from among the character regions included in the image data, as a character region in which an object image is to be arranged in the image conversion process.

When “Character Region Containing [a specified character] in Character String” is selected, a character region containing a specific character (e.g., “@” or “#”) specified by the user is detected, from among the character regions included in the image data, as a character region in which an object image is to be arranged in the image conversion process.

When “Range Marked with Symbol” is selected, a character region identified by a symbol (e.g., < > or “ ”) specified by the user is detected, from among the character regions included in the image data, as a character region in which an object image is to be arranged in the image conversion process.

When “Character Region Containing [a specified color]” is selected, a character region including characters in a color (e.g., red or green) specified by the user is detected, from among the character regions included in the image data, as a character region in which an object image is to be arranged in the image conversion process.

The size setting 706 allows the user to specify how to determine the size of the object image to be arranged in the image conversion process. In this embodiment, the user can select either “Fit to Original Region” or “Specify in Character String” as the setting value for the size setting 706.

When “Fit to Original Region” is selected, the size of the object image is determined based on the size of the character region detected according to the condition specified in the image generation region setting 705. For example, the maximum size that fits within the rectangle used to detect the character region is set as the size of the object image.

When “Specify in Character String” is selected, the size of the object image is determined based on the size indicated by the characters included in the character region detected according to the condition specified in the image generation region setting 705. For example, when the user selects “Specify in Character String” and further specifies “<>,” if the detected character region includes a character string “<256*256>,” the size of the object to be arranged at the position of this character region is set to a height of 256 mm and a width of 256 mm.

When the user presses an OK button 707, the setting values specified in the image generation region setting 705 and the size setting 706 are transmitted to the setting reception unit 308 of the server 1120 and stored in the setting storage unit 306.

FIG. 7C illustrates the font settings screen 708. The font settings screen 708 includes a font size setting 709 and a font color setting 710.

The font size setting 709 allows the user to specify how to determine the size of the character image to be arranged in the image conversion process. In this embodiment, the user can select either “Fit to Original Region” or “Specify in Character String” as the setting value for the font size setting 709.

When “Fit to Original Region” is selected, the size of the character image is determined based on the size of the target character region. For example, the maximum size that fits within a rectangular region (not illustrated) including the target character region is set as the size of the character image.

When “Specify in Character String” is selected, the size of the character image is determined based on the size indicated by the characters included in the target character region. For example, when the user selects “Specify in Character String” and further specifies “First Number,” if the character region includes “16,” the size of the character image to be arranged at the position of that character region is set to 16 pixels.

The font color setting 710 allows the user to specify how to determine the color of the character image to be arranged in the image conversion process. In this embodiment, the user can select either “Match Original Character Color” or “Specify in Character String” as the setting value for the font color setting 710.

When “Match Original Character Color” is selected, the character image is arranged using the same color as the characters included in the target character region. When “Specify in Character String” is selected, the character image is arranged using the color indicated by the characters included in the target character region. For example, when the user selects “Specify in Character String” and further specifies “#Color Code,” if the character region includes a character string “#FF0000,” a red character image is arranged in the character region.

When the user presses an OK button 711, the setting values specified in the font size setting 709 and the font color setting 710 are transmitted to the setting reception unit 308 of the server 1120 and stored in the setting storage unit 306.

In this manner, in the present embodiment, before the image conversion process is performed, the user configures detailed settings related to the image conversion process, and the image conversion process is performed based on the detailed settings.

FIG. 8 is a flowchart illustrating the operation of the server 1120 in the image conversion process performed by the information processing system 10 illustrated in FIG. 1. The flowchart of FIG. 8 is implemented when the CPU 121 loads a control program stored in the ROM 123 or the HDD 124 into the RAM 122 and executes it. In this embodiment, as an example, it is assumed that “Region Enclosed by Figure” is selected and “Rectangle” is specified in the image generation region setting 705 on the image generation settings screen 704.

In FIG. 8, first, the CPU 121 acquires the image data of the manuscript 601 transmitted from the MFP 1100 in step S405 (S801).

Next, the CPU 121 controls the main control unit 303 to cause the image analysis unit 304 to detect a rectangular region from the image data of the manuscript 601 (S802). For example, the image analysis unit 304 uses a trained model that has learned a plurality of different rectangular images to detect rectangular regions from the image data of the manuscript 601. The main control unit 303 stores the position information and size information of the detected rectangular region as information on this region.

Next, the CPU 121 controls the main control unit 303 to cause the image analysis unit 304 to detect character regions from the image data of the manuscript 601 (S803). The image analysis unit 304 extracts the content of the characters included in the detected character regions. The main control unit 303 stores the position information and size information of the detected character regions, as well as the extracted character content, as information on the character regions. In this embodiment, the image analysis unit 304 identifies each of the characters in the detected character regions, and the character content is stored as character string data indicating a string of the characters. Step S803 may be performed using a trained model that has learned from a large number of characters.

Next, the CPU 121 selects one of the character regions detected in step S803 and determines whether this character region satisfies the condition specified in the image generation region setting 705. Specifically, the CPU 121 controls the main control unit 303 to determine whether the character region is enclosed by a rectangle based on the information on the character region and the information on the rectangular region (S804). In step S804, for example, the determination is made as to whether the character region is contained within the rectangular region. Alternatively, in step S804, the determination may also be made by another method, such as whether the character region is located in a specific positional relationship with respect to the rectangular region.

If it is determined in step S804 that the character region is not enclosed by a rectangle, i.e., if the character region does not satisfy the condition specified in the image generation region setting 705, the process proceeds to step S805. In step S805, the CPU 121 controls the main control unit 303 to cause the image analysis unit 304 to extract color information of the characters included in the character region. Next, the CPU 121 controls the main control unit 303 to set the font color for the character region (S806). For example, when “Match Original Character Color” is specified in the font color setting 710, the most prevalent color in the character region is set as the font color for the character region. On the other hand, when “Specify in Character String” is specified in the font color setting 710, the color indicated by the characters included in the character region (e.g., “#FF0000,” corresponding to red) is set as the font color for the character region.

Next, the CPU 121 controls the main control unit 303 to set the font size for the character region (S807). For example, when “Fit to Original Region” is specified in the font size setting 709, the maximum size that fits within a rectangular region (not illustrated) including the character region is set as the font size for the character region. On the other hand, when “Specify in Character String” is specified in the font size setting 709, the size indicated by the characters included in the character region (e.g., 16) is set as the font size for the character region.

Next, the CPU 121 controls the main control unit 303 to cause the image generation unit 305 to arrange, at a location corresponding to the character region, a character image obtained by converting the characters included in the character region into characters of a predetermined font (S808). These characters are rendered in the color set in step S806 and in the font size set in step S807. The process then proceeds to step S812 (described later). In this manner, in the present embodiment, a character region determined not to be enclosed by a rectangle is replaced with a character image obtained by converting the characters included in the character region into characters of a predetermined font.

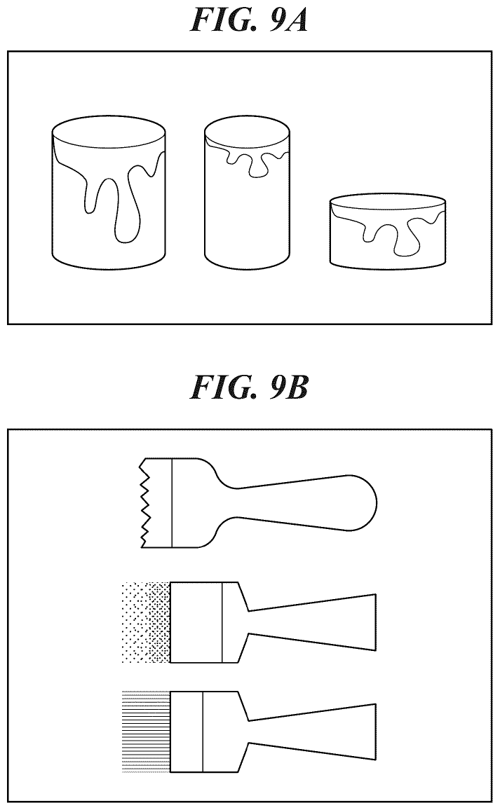

If it is determined in step S804 that the character region is enclosed by a rectangle, i.e., if the character region satisfies the condition specified in the image generation region setting 705, the process proceeds to step S809. In step S809, the CPU 121 uses the image generation AI to generate an image of the object indicated by the characters included in the character region. Specifically, the CPU 121 controls the main control unit 303 to instruct the image generation unit 305 to generate an image of the object indicated by the characters included in the character region. The image generation unit 305 inputs a prompt to the image generation AI to output the image of the object. The image generation AI has been trained in advance as a trained model using a large number of images and information indicating what each image represents. For example, as the correct images for the input “paint,” the image generation AI has learned a plurality of images with different shapes, as illustrated in FIG. 9A. Similarly, as the correct images for the input “brush,” the image generation AI has learned a plurality of images with different tip shapes, handle shapes, and the like, as illustrated in FIG. 9B. In this manner, by using a trained model trained on various images, the image generation AI can generate an object image similar to the images used for training as an output image in response to the input prompt. In this embodiment, in step S809, the image generation unit 305 may alternatively select an image of the object indicated by the characters included in the character region from among a plurality of pre-prepared object images.

Next, the CPU 121 adjusts the size of the object image generated by the image generation unit 305 (S810). For example, when “Fit to Original Region” is specified in the size setting 706, the CPU 121 controls the main control unit 303 to adjust the size of the object image to the maximum size that fits within the rectangular region enclosing the character region. On the other hand, when “Specify in Character String” is selected and “< >” is specified in the size setting 706, the control is performed as follows. Specifically, the CPU 121 controls the main control unit 303 to adjust the size of the object image to a height of 256 mm and a width of 256 mm based on the character string “<256*256>” included in the character region. In this embodiment, the output size may alternatively be specified to the image generation AI, in which case step S810 may be skipped.

Next, the CPU 121 controls the main control unit 303 to arrange the object image, whose size has been adjusted in step S810, at a location corresponding to the rectangular region (S811). In this manner, in the present embodiment, a character region determined to be enclosed by a rectangle is replaced with an image of the object indicated by the characters included in the character region.

Next, the CPU 121 controls the main control unit 303 to determine whether there are any unprocessed character regions among the character regions detected in step S803 (S812). If it is determined that there are unprocessed character regions, the CPU 121 selects one of the unprocessed character regions. Thereafter, the process returns to step S804, and processing is performed on the selected character region. In this manner, in the present embodiment, processing is performed on all the character regions detected in step S803, and the image data 602 illustrated in FIG. 6B is generated. In the image data 602, for example, a paint image 603, a hand image 604, and a brush image 605 are arranged respectively at the positions of the handwritten words “paint,” “hand,” and “brush,” each enclosed by a rectangle in the image data of the manuscript 601. Additionally, in the image data 602, a character image 606 and a character image 607 are arranged at the positions of the handwritten words “WET” and “PAINT,” which are not enclosed by a rectangle in the image data of the manuscript 601. The character image 606 is an image obtained by converting the word “WET” into a predetermined font, and the character image 607 is an image obtained by converting the word “PAINT” into a predetermined font.

If it is determined in step S812 that there are no unprocessed character regions, the CPU 121 controls the main control unit 303 to cause the MFP image transmission unit 307 to transmit the image data 602 to the MFP 1100 (S813). Thereafter, the process ends.

According to the embodiment described above, in the image data of the manuscript 601, a character region that satisfies the condition specified in the image generation region setting 705 is replaced with an image of the object indicated by the characters included in the character region. As a result, it is possible to generate image data including an image of an object such as an illustration or a figure from a handwritten manuscript and arrange it in a region that satisfies a predetermined condition.

In the embodiment described above, the image of the object indicated by the characters included in the character region that satisfies the condition specified in the image generation region setting 705 is arranged at a location corresponding to the character region in the image data of the manuscript 601. As a result, it is possible to generate image data including images of objects with the same layout as the handwritten manuscript.

In the embodiment described above, the character region that satisfies the condition specified in the image generation region setting 705 is a character region enclosed by a figure of a shape specified by the user. As a result, the user can simply prepare a manuscript in which characters are enclosed by a figure of the specified shape to generate image data that includes an image of the object indicated by the characters.

In the embodiment described above, the size of the image of the object may be determined based on the size indicated by the characters included in the character region that satisfies the condition specified in the image generation region setting 705. This allows the object image to be arranged at a size intended by the user.

In the embodiment described above, the size of the image of the object may be determined based on the size of the character region that satisfies the condition specified in the image generation region setting 705. This allows the object image to be arranged at an appropriate size without requiring the user to specify the size.

In the embodiment described above, in the image data of the manuscript 601, a character region that does not satisfy the condition specified in the image generation region setting 705 is replaced with a character image obtained by converting the characters included in the character region into a predetermined font. This makes it possible to generate image data in which handwritten characters are replaced with images of characters in a font with improved appearance.

In the embodiment described above, the character image obtained by converting the characters included in the character region that does not satisfy the condition specified in the image generation region setting 705 into a predetermined font is arranged at a location corresponding to the character region in the image data of the manuscript 601. This makes it possible to generate image data in which handwritten characters are replaced with images of characters in a font with improved appearance, with the same layout as the handwritten manuscript.

In the embodiment described above, the size of the character image may be determined based on the size indicated by the characters included in the character region that does not satisfy the condition specified in the image generation region setting 705. This allows the character image to be arranged at a character size intended by the user.

In the embodiment described above, the size of the character image may be determined based on the size of the character region that does not satisfy the condition specified in the image generation region setting 705. This allows the character image to be arranged at an appropriate character size without requiring the user to specify the size.

In the embodiment described above, the character region in the image data of the manuscript 601 that does not satisfy the condition specified in the image generation region setting 705 may be replaced with a character image obtained by converting the characters included in the character region into a predetermined font in the color indicated by the characters. This allows the character image to be arranged in the color intended by the user.

In the embodiment described above, the character region in the image data of the manuscript 601 that does not satisfy the condition specified in the image generation region setting 705 may be replaced with a character image obtained by converting the characters included in the character region into a predetermined font in the same color as the characters. This allows the character image to be arranged in an appropriate color without requiring the user to specify the color.

In the above embodiment, as an example, a case has been described in which “Region Enclosed by Figure” is selected and “Rectangle” is specified in the image generation region setting 705 on the image generation settings screen 704. However, when a different setting is made in the image generation region setting 705, the processes in steps S802, S804, S810, and S811 may differ in part. Accordingly, the following will describe steps S802, S804, S810, and S811 when a different setting is made in the image generation region setting 705.

As another example, a case will be described in which “Character Region Containing [a specified character] in Character String” is selected and “@” is specified in the image generation region setting 705. In this case, in step S802, the CPU 121 controls the main control unit 303 to cause the image analysis unit 304 to detect a first character region including the specified character “@” from the image data of the manuscript 601. In step S804, the CPU 121 controls the main control unit 303 to determine whether the character region is the first character region based on information on the first character region and information on the character region. If it is determined that the character region is not the first character region, i.e., if the character region does not satisfy the condition specified in the image generation region setting 705, step S805 is performed for the character region. On the other hand, if it is determined that the character region is the first character region, i.e., if the character region satisfies the condition specified in the image generation region setting 705, step S809 is performed for the character region. In step S810, for example, when “Fit to Original Region” is specified in the size setting 706, the CPU 121 controls the main control unit 303 to adjust the size of the object image to the maximum size that fits within a rectangular region (not illustrated) including the first character region. In step S811, the CPU 121 controls the main control unit 303 to arrange the object image, whose size has been adjusted in step S810, at a location corresponding to the first character region. In this manner, when “Character Region Containing [a specified character] in Character String” is selected in the image generation region setting 705, the user can simply prepare a manuscript in which a character string including the specified character is written to generate image data that includes an image of the object indicated by the character string.

As another example, a case will be described in which “Range Marked with Symbol” is selected and “< >” is specified in the image generation region setting 705. In this case, in step S802, the CPU 121 controls the main control unit 303 to cause the image analysis unit 304 to detect a second character region including “< >” specified by the user from the image data of the manuscript 601. In step S804, the CPU 121 controls the main control unit 303 to determine whether the character region is the second character region based on information on the second character region and information on the character region. If it is determined that the character region is not the second character region, i.e., if the character region does not satisfy the condition specified in the image generation region setting 705, step S805 is performed for the character region. On the other hand, if it is determined that the character region is the second character region, i.e., if the character region satisfies the condition specified in the image generation region setting 705, step S809 is performed for the character region. In step S810, for example, when “Fit to Original Region” is specified in the size setting 706, the CPU 121 controls the main control unit 303 to adjust the size of the object image to the maximum size that fits within a rectangular region (not illustrated) including the second character region. In step S811, the CPU 121 controls the main control unit 303 to arrange the object image, whose size has been adjusted in step S810, at a location corresponding to the second character region. In this manner, when “Range Marked with Symbol” is selected, the user can simply prepare a manuscript in which a character string composed of the specified symbol and characters is written to generate image data that includes an image of the object indicated by the character string.

As still another example, a case will be described in which “Character Region Containing [a specified color]” is selected and “Green” is specified in the image generation region setting 705. In this case, in step S802, the CPU 121 controls the main control unit 303 to cause the image analysis unit 304 to detect a third character region including characters of the specified green color from the image data of the manuscript 601. In step S804, the CPU 121 controls the main control unit 303 to determine whether the character region is the third character region based on information on the third character region and information on the character region. If it is determined that the character region is not the third character region, i.e., if the character region does not satisfy the condition specified in the image generation region setting 705, step S805 is performed for the character region. On the other hand, if it is determined that the character region is the third character region, i.e., if the character region satisfies the condition specified in the image generation region setting 705, step S809 is performed for the character region. In step S810, for example, when “Fit to Original Region” is specified in the size setting 706, the CPU 121 controls the main control unit 303 to adjust the size of the object image to the maximum size that fits within a rectangular region (not illustrated) including the third character region. In step S811, the CPU 121 controls the main control unit 303 to arrange the object image, whose size has been adjusted in step S810, at a location corresponding to the third character region. In this manner, when “Character Region Containing [a specified color]” is selected, the user can simply prepare a manuscript in which characters of the specified color are written to generate image data that includes an image of the object indicated by the characters.

In the above embodiment, as an example, a configuration has been described in which part of the image conversion process (the flowchart of FIG. 8) is performed by the server 1120; however, the embodiment is not limited to this configuration. For example, the entire image conversion process may be performed by the MFP 1100. In such a configuration, the MFP 1100 includes at least the main control unit 303, the image analysis unit 304, the image generation unit 305, and the setting storage unit 306 described above. In this configuration, the content of the image conversion process differs in part from that described above. The following will describe the parts that differ from the flowcharts of FIGS. 4 and 8 described above.

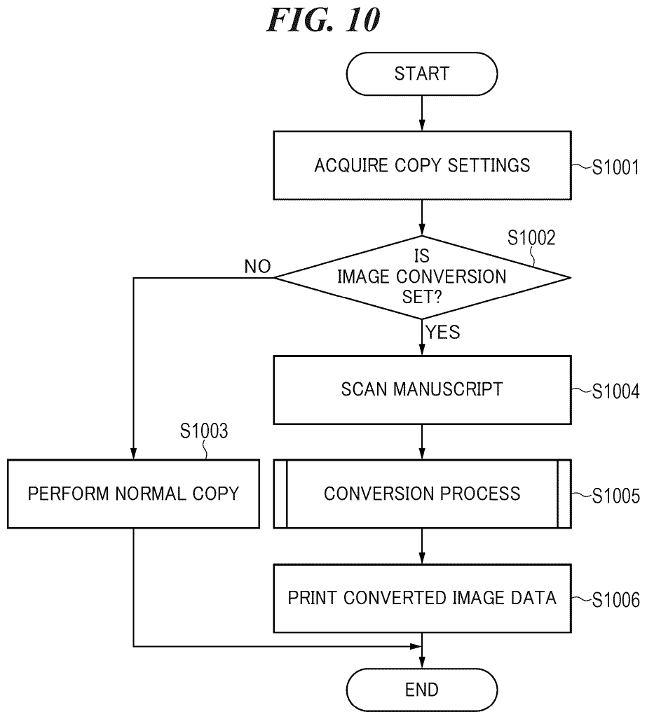

FIG. 10 is a flowchart illustrating the procedure of the image conversion process performed by the MFP 1100 illustrated in FIG. 1. The flowchart of FIG. 10 is implemented when the CPU 101 loads the control program of the function application 205 stored in the ROM 103 or the HDD 104 into the RAM 102 and executes it. Similarly to the flowchart of FIG. 4 described above, the flowchart of FIG. 10 is initiated, for example, when the MFP 1100 receives an instruction from a user to perform copying.

In FIG. 10, first, steps S1001 and S1002, which are the same processes as steps S401 and S402 described above, are performed.

If it is determined in step S1002 that image conversion has not been set, the process proceeds to step S1003, which is the same process as step S403 described above. Thereafter, the process ends.

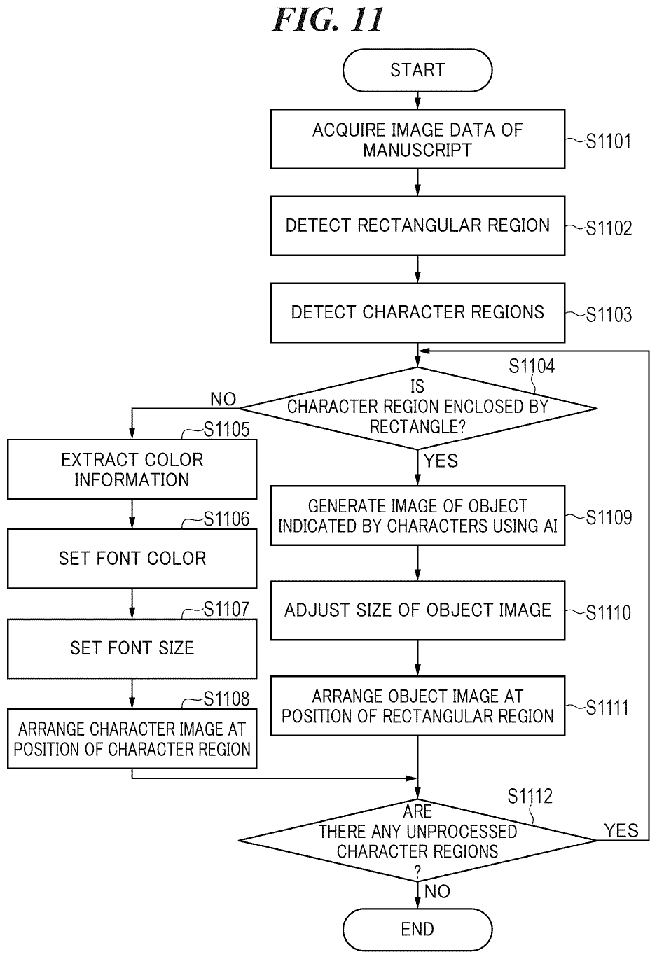

If it is determined in step S1002 that image conversion has been set, the process proceeds to step S1004, which is the same process as step S404 described above. Subsequently, the function application 205 instructs the main control unit 303 of the MFP 1100 to perform the conversion process illustrated in FIG. 11 (S1005).

Next, the function application 205 instructs the job control unit 203 to print the converted image data obtained through the conversion process (S1006). The job control unit 203 prints the received converted image data in accordance with the print-related settings among the copy settings. Thereafter, the process ends.

FIG. 11 is a flowchart illustrating the procedure of the conversion process performed in step S1005 of FIG. 10. The flowchart of FIG. 11 is implemented when the CPU 101 loads the control program stored in the ROM 103 or the HDD 104 into the RAM 102 and executes it.

In FIG. 11, steps S1101 to S1112, which are the same processes as steps S801 to S812 described above, are performed.

If it is determined in step S1112 that there are unprocessed character regions among the character regions detected in step S1103, the CPU 101 selects one of the unprocessed character regions. Thereafter, the process returns to step S1104, and processing is performed on the selected character region. If it is determined in step S1112 that there are no unprocessed character regions among the character regions detected in step S1103, this process ends and proceeds to step S1006 described above.

In this manner, in a configuration where the entire image conversion process is performed by the MFP 1100 as well, it is possible to generate image data including an image of an object such as an illustration or a figure from a handwritten manuscript.

In addition, in step S1109 of the flowchart illustrated in FIG. 11 described above, the MFP 1100 may be configured to output a prompt for generating an object image to another device equipped with an image generation AI. In other words, the MFP 1100 may acquire an object image generated by the other device. This makes it possible to generate image data including an image of an object such as an illustration or a figure from a handwritten manuscript even in a configuration where the MFP 1100 is not equipped with an image generation AI.

According to the embodiment(s) described above, it is possible to generate image data including an image of an object such as an illustration or a figure from a handwritten manuscript and arrange it in a region that satisfies a predetermined condition.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-002282, filed Jan. 7, 2025, which is hereby incorporated by reference herein in its entirety.

What is claimed is:

1. An information processing apparatus, comprising:
one or more processors; and
at least one memory coupled to the one or more processors and storing instructions that, when executed by the one or more processors, cause the one or more processors to perform operations comprising:
acquiring image data obtained by reading a manuscript;
detecting a character region including one or more characters from the image data;
determining whether the detected character region satisfies a predetermined condition; and
performing, when the character region satisfies the condition, processing on the image data to replace the character region with an image of an object indicated by the one or more characters included in the character region.

2. The information processing apparatus according to claim 1, wherein the image of the object is arranged at a location corresponding to the character region that satisfies the condition in the image data.

3. The information processing apparatus according to claim 1, wherein the character region that satisfies the condition is a character region enclosed by a figure of a shape specified by a user.

4. The information processing apparatus according to claim 1, wherein the character region that satisfies the condition is a character region containing a specific character specified by a user.

5. The information processing apparatus according to claim 1, wherein the character region that satisfies the condition is a character region identified by a symbol specified by a user.

6. The information processing apparatus according to claim 1, wherein the character region that satisfies the condition is a character region including one or more characters in a color specified by a user.

7. The information processing apparatus according to claim 1, wherein a size of the image of the object is determined based on a size of the character region that satisfies the condition.

8. The information processing apparatus according to claim 1, wherein a size of the image of the object is determined based on a size indicated by one or more characters included in the character region that satisfies the condition.

9. The information processing apparatus according to claim 1, wherein the operations further comprise performing, when the character region does not satisfy the condition, processing on the image data to replace the character region with a character image obtained by converting the one or more characters included in the character region into a predetermined font.

10. The information processing apparatus according to claim 9, wherein the character image is arranged at a location corresponding to the character region that does not satisfy the condition in the image data.

11. The information processing apparatus according to claim 9, wherein a size of the character image is determined based on a size of the character region that does not satisfy the condition.

12. The information processing apparatus according to claim 9, wherein a size of the character image is determined based on a size indicated by one or more characters included in the character region that does not satisfy the condition.

13. The information processing apparatus according to claim 9, wherein the character image is obtained by converting the one or more characters included in the character region into the predetermined font in the same color as the characters.

14. The information processing apparatus according to claim 9, wherein the character image is obtained by converting the one or more characters included in the character region into the predetermined font in a color indicated by the characters.

15. The information processing apparatus according to claim 1, wherein the operations further comprise receiving the image data from an image forming apparatus that reads the manuscript and generates the image data.

16. The information processing apparatus according to claim 1, wherein the information processing apparatus is an image forming apparatus that reads the manuscript and generates the image data.

17. The information processing apparatus according to claim 1, wherein the manuscript is a handwritten manuscript.

18. A control method for an information processing apparatus, comprising:
acquiring image data obtained by reading a manuscript;
detecting a character region including one or more characters from the image data;
determining whether the detected character region satisfies a predetermined condition; and
performing, when the character region satisfies the condition, processing on the image data to replace the character region with an image of an object indicated by the one or more characters included in the character region.

19. A non-transitory computer-readable medium comprising computer-executable instructions stored thereon that, when executed by a computer, cause the computer to perform a control method for an information processing apparatus, the control method comprising:
acquiring image data obtained by reading a manuscript;
detecting a character region including one or more characters from the image data;
determining whether the detected character region satisfies a predetermined condition; and
performing, when the character region satisfies the condition, processing on the image data to replace the character region with an image of an object indicated by the one or more characters included in the character region.
